(19) United States
(12) Patent Application Publication
(10) Pub. No.: US 2026/0058711 A1
(43) Pub. Date: Feb. 26, 2026

(54) INTER-FREQUENCY CARRIER LAYER 3 MEASUREMENT

(71) Applicant: APPLE INC., Cupertino, CA (US)

(72) Inventors: Jie Cui, San Jose, CA (US); Yang Tang, San Jose, CA (US); Manasa Raghavan, Sunnyvale, CA (US); Dawei Zhang, Saratoga, CA (US); Xiang Chen, Campbell, CA (US); Qiming Li, Beijing (CN); Yuexia Song, Beijing (CN); Rolando E Bettancourt Ortega, Munich (DE); Hong He, San Jose, CA (US); Haitong Sun, Cupertino, CA (US)

(21) Appl. No.: 18/996,225

(22) PCT Filed: Jul. 21, 2023
(86) PCT No.: PCT/US2023/070676

§ 371 Date: Jan. 17, 2025

Related U.S. Application Data
(60) Provisional application No. 63/370,575, filed on Aug. 5, 2022.

(51) Int. Cl. H04B 7/06; H04B 17/318; H04L 5/00

(52) U.S. Cl. CPC H04B 7/06952; H04B 17/328; H04L 5/0026; H04L 5/0044

(57) ABSTRACT

A user equipment (UE) may be configured to perform layer 3 measurements on an inter-frequency carrier when configured by a long term evolution (LTE) serving cell or a new radio (NR) Frequency Range 1 (FR1) serving cell. The user equipment may perform reception (Rx) beam sweeping, and determine one or more inter-frequency carrier L3 measurements based on the Rx beam sweeping. The UE may report the one or more inter-frequency carrier L3 measurements to a network node.

### TECHNICAL FIELD

This application relates generally to wireless communication systems, including layer 3 measurements on an inter-frequency carrier.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a flow chart of a method for a UE to perform a layer 3 (e.g., L3 RSSI) measurement in accordance with some embodiments.

FIG. 2 illustrates a flow chart of a method for a UE to perform an RSSI measurement on an inter-frequency carrier using information from a serving cell in FR2-1 or FR2-2 in accordance with some embodiments.

FIG. 3 illustrates an example architecture of a wireless communication system, according to embodiments disclosed herein.

FIG. 4 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Some of the goals of wireless network communication systems are to improve reliability and increase bandwidth. New Radio Unlicensed (NR-U) is one way in which cellular operators are seeking to accomplish these goals. NR-U is a mode of operation that cellular operators may use to integrate the unlicensed spectrum into 5G networks.

Some of the unlicensed spectrum includes high bands. It may be desirable to expand coverage into these higher frequency bands for additional bandwidth. For example, frequency Range 2-2 (FR 2-2) include frequency bands from 52.6 GHz to 71 GHz. Operating on such high frequencies may necessity the use of beam forming due to the limited range of the high frequencies. Introducing beams results in the UE needing to consider which beam should be used should be used to perform layer 3 (L3) measurements.

Accordingly, a standard may be adopted to define an expected operation of the UE. For example, for the quasi co-location (QCL) Type-D of L3-received signal strength indicator (RSSI) measurement for unlicensed operation in FR2-2, if explicit TCI state is configured, the UE may use the TCI state. Further, the UE may use the QCL type-D of the latest Physical Downlink Shared Channel (PDSCH) reception or latest Control Resource Set (CORESET) monitoring for RSSI measurement, if the explicit Transmission Configuration Indication (TCI) state is not configured. A dynamic update mechanism for TCI-State in RSSI measurement time configuration (RMTC)-Config has not been considered. Additionally, the explicit TCI state may be configured at least in RMTC-Config.

These are rules that can also apply to inter-frequency measurements. For example, for inter-frequency L3-RSSI measurement, the TCI state configured may be with respect to the target frequency TCI state. For a given L3-RSSI measurement occasion, the UE may identify the last PDSCH reception or last configured CORESET monitoring (whichever is later) before the L3-RSSI measurement occasion, and use the QCL Type-D of that for L3-RSSI monitoring. However, for inter-frequency measurements, since the measurement is not on the current serving cell, the UE does not have knowledge of the PDSCH or CORESET for monitoring.

An RSSI measurement is defined as an inter-frequency measurement provided that the RSSI measurement bandwidth is not contained within the current carrier bandwidth of the UE. In some embodiments, the UE physical layer may be capable of performing the RSSI measurements on one or more inter-frequency carriers operating with CCA if the carrier(s) are indicated by higher layers, and report the RSSI measurements to higher layers. The UE physical layer may provide to higher layers a single RSSI sample for each OFDM symbol within each configured RSSI measurement duration occurring with a configured RSSI measurement timing configuration periodicity, rmtc-Periodicity.

For performing RSSI measurement in FR2-2, a UE can assume the configured RSSI measurement resources are QCL-ed with TypeD to the downlink resource associated with the TCI state provided in the RMTC configuration. If the configured RSSI measurement resources are not confined within the bandwidth of any serving cell, UE can assume that the measurement resources are QCL-ed with TypeD to the DL RS associated with the TCI state of the active BWP of the carrier on which the RMTC configuration is provided. If no TCI state is provided in the RMTC configuration, UE can assume the configured RSSI measurement resources are QCL-ed with TypeD to one of the latest received PDSCH and the latest monitored CORESET in the active bandwidth part (BWP) of the carrier on which the RMTC configuration is provided.

However, issues may arise for inter-frequency RSSI measurements when FR2-2 is used. For example, if the carrier on which the RMTC configuration is provided in is a LTE carrier or NR FR1 carrier, the QCL with type D is not available to be an assumption in such case. If the RMTC is configured by LTE serving cell or NR FR1 serving cell for an inter-frequency RSSI measurement there are four cases that should be clarified. A first case occurs when the TCI is provided to UE and TCI is associated with an RS on inter-frequency carrier, but UE has no serving cell in FR2-1 or FR2-2. A second case occurs when TCI is provided to UE and TCI is associated with an RS on inter-frequency or intra-frequency carrier, and UE has at least one existing serving cell in FR2-1 or FR2-2. A third case occurs if TCI is not provided to UE, and UE has no serving cell in FR2-1 or FR2-2. A fourth case occurs if TCI is not provided to UE, and UE has at least one 4 existing serving cell in FR2-1 or FR2-2. Embodiments herein address handling of inter-frequency RSSI measurements for these cases.

The inter-frequency carrier on which RSSI measurement is configured is referred to herein as “inter-frequency RSSI carrier.” Further, where a TCI is associated with a reference signal on an inter-frequency carrier, the inter-frequency carrier of the reference signal may be the inter-frequency RSSI carrier or another inter-frequency carrier. In other words the inter-frequency carrier of the reference signal may be the same or different from the inter-frequency carrier on which RSSI measurement is configured.

While embodiments herein refer to RSSI measurements, the embodiments may be applied to other layer three (L3) measurements.

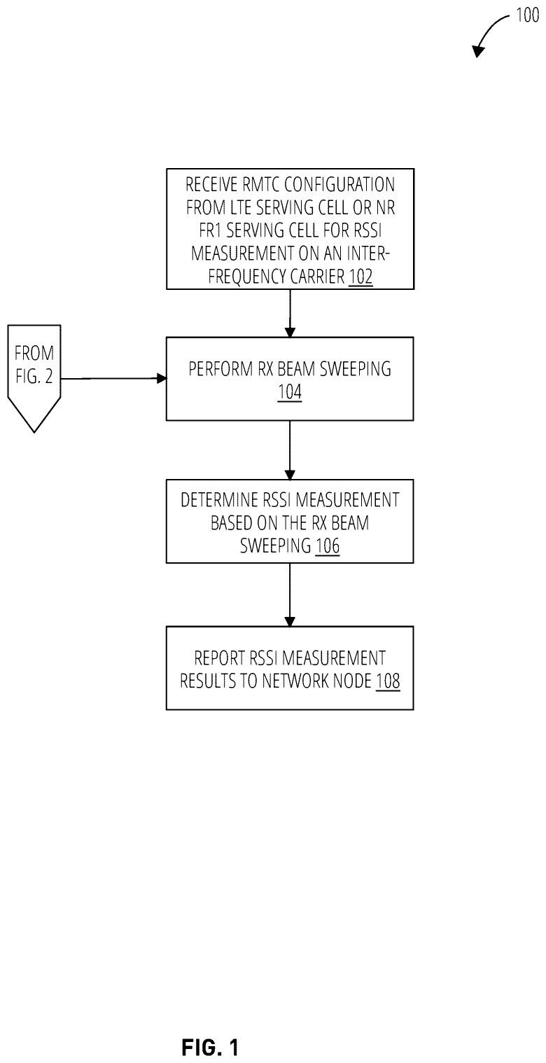

FIG. 1 illustrates a flow chart of a method 100 for a UE to perform a layer 3 (e.g., L3 RSSI) measurement in accordance with some embodiments. As shown, the UE may receive 102 an RMTC configuration from an LTE serving cell or an NR FR1 serving cell for RSSI measurement on an inter-frequency carrier. As previously discussed, when the RMTC is configured by the LTE serving cell or an NR FR1 serving cell for RSSI measurement on an inter-frequency carrier, the QCL with type D is not available to be an assumption. Accordingly, the UE may perform steps in addition to simply measuring RSSI.

For example, the UE may perform 104 Reception (Rx) beam sweeping. The UE may determine 106 an RSSI measurement results based on the Rx beam sweeping. The UE may report 108 the RSSI measurement results to a network node.

Implementation of the steps of this method 100 may vary based on the scenario that the UE is in as well as based on the systems implementation.

### Case 1

A UE may be in a scenario where the TCI of QCLed type D is provided to the UE and the TCI is associated with a reference signal on an inter-frequency carrier, but the UE has no serving cell in FR2-1 or FR2-2 (i.e., Case 1). Case 1 may be approached using the two options outlined below to implement the RSSI measurement method 100.

In a first option for Case 1, the UE may perform 104 Rx beam sweeping on the reference signal associated with the TCI. To perform the RX beam sweeping, the UE may tune to the inter-frequency carrier of the reference signal for the reference signal measurement. The UE may use local Rx beams to measure the reference signal's Reference Signal Received Power (RSRP), Reference Signal Received Quality (RSRQ), or Signal to Interference and Noise Ratio (SINR).

The UE may determine 106 the RSSI measurement based on the RX beam sweep by using the reference signal measurements to determine an Rx beam on which to measure RSSI. Based on the Rx beam sweeping results, the UE may determine the Rx beam information for RSSI measurement on target inter-frequency RSSI carrier. In some embodiments, the Rx beam determination may be based on a strongest measurement results of RSRP, RSRQ, or SINR. In some embodiments, the Rx beam determination may be based on the measurement results of RSRP, RSRQ, or SINR that were above a specific threshold.

The UE may measure RSSI on the inter-frequency RSSI carrier by using the beam or QCL type D information determined by the reference signal measurement. In other words, the UE may determine beam information for an RSSI measurement based on results of the beam sweep used for the reference signal measurement. The UE can report 108 the RSSI measurement result back to a network node.

A second option for a UE in Case 1 includes the following. Since the reference signal is on another inter-frequency carrier and not on a current serving carrier, the UE may perform 104 the Rx beam sweeping and directly measure the RSSI without performing a reference signal measurement. For example, the UE may perform an RSSI measurement on the inter-frequency RSSI carrier by using Rx beam sweeping.

In some embodiments, the UE may use Rx beam sweeping to measure RSSI and determine the RSSI measurement results based on the strongest Rx beam. The strongest Rx beam refers to the Rx beam with the highest RSSI value. Accordingly, the UE may perform 104 a beam sweep to measure the RSSI, compare the RSSI measurements for the beams, determine 106 the RSSI measurement by selecting the RSSI measurement of the RX beam with the highest RSSI value, and report 108 the RSSI measurement of the strongest Rx beam to a network node.

In some embodiments, the UE may use Rx beam sweeping to measure RSSI and determine 106 the RSSI measurement results based on an Rx beam above a specific threshold. For example, an embodiment may have a zero decibel-milliwatts (dBm) threshold. When the UE performs 104 the Rx beam sweep, the UE determines Rx beams with an RSSI measurement above the zero dBm threshold. If there is a single Rx beam with an RSSI measurement value above the threshold the UE may report 108 the value of that Rx beam to the network node. In some embodiments, if there are multiple Rx beams with a RSSI value above the threshold, the UE may randomly select, from those Rx beams above the threshold, which Rx beam's RSSI value to report 108 to the network node.

In some embodiments, the UE may perform 104 Rx Beam sweeping and determine 106 multiple values for the RSSI measurement. For example, the UE may use Rx beam sweeping to measure RSSI and store the RSSI measurement results. In some embodiments, the UE may determine which RSSI measurement results to store by determining which Rx beams were above a specific threshold. For example, the UE may store the RSSI measurement results for Rx beams above a zero dBm threshold. In some embodiments, the UE may store all measurement results. For example if the beam sweep includes eight RSSI measurements, the UE may store all eight RSSI measurement results. The UE may report 108 the stored measurements back to the network node. To report multiple values to the network node, the RSSI measurement results may be associated with a beam index or associated with a resource signal index (e.g., QCL type D SSB index) in the report.

In some embodiments, the UE may perform 104 Rx Beam sweeping and determine 106 the RSSI measurement by taking an average of the RSSI values. For example, the UE may use Rx beam sweeping to measure RSSI and determine the RSSI measurement results based on the average of the Rx beams measured. In other words, the UE may determine an average RSSI value among Rx beams and report that average value to the network node. For example, if the UE performs a beam sweep resulting in eight RSSI values, the UE may average the eight values and report 108 the average RSSI value to the network node. In some embodiments, the average may be an average of the RSSI measurements above a specific threshold. In some embodiments, the average may be an average of all the RSSI measurements.

### Case 2

At other times, a UE may be in a scenario where the TCI of QCLed type D is provided to the UE and the TCI is associated with a reference signal on an inter-frequency carrier, and the UE has at least one existing serving cell in FR2-1 or FR2-2 (i.e., Case 2). Case 2 may be approached using the three options outlined below.

In a first option for Case 2, the UE may apply the first option described with reference to Case 1. Accordingly, the UE may use beam sweeping to determine the Rx beam info for RSSI measurement on target inter-frequency RSSI carrier as described above.

In a second option for Case 2, the UE may apply the second option described with reference to Case 1. Accordingly, the UE may use beam sweeping to measure the RSSI directly as described above.

In other words, the first and second option described with reference to Case 1 may be applied in scenarios where the TCI of QCLed type D is provided to the UE and TCI is associated with a reference signal on an inter-frequency or intra-frequency carrier, whether or not the UE has an existing serving cell in FR2-1 or FR2-2.

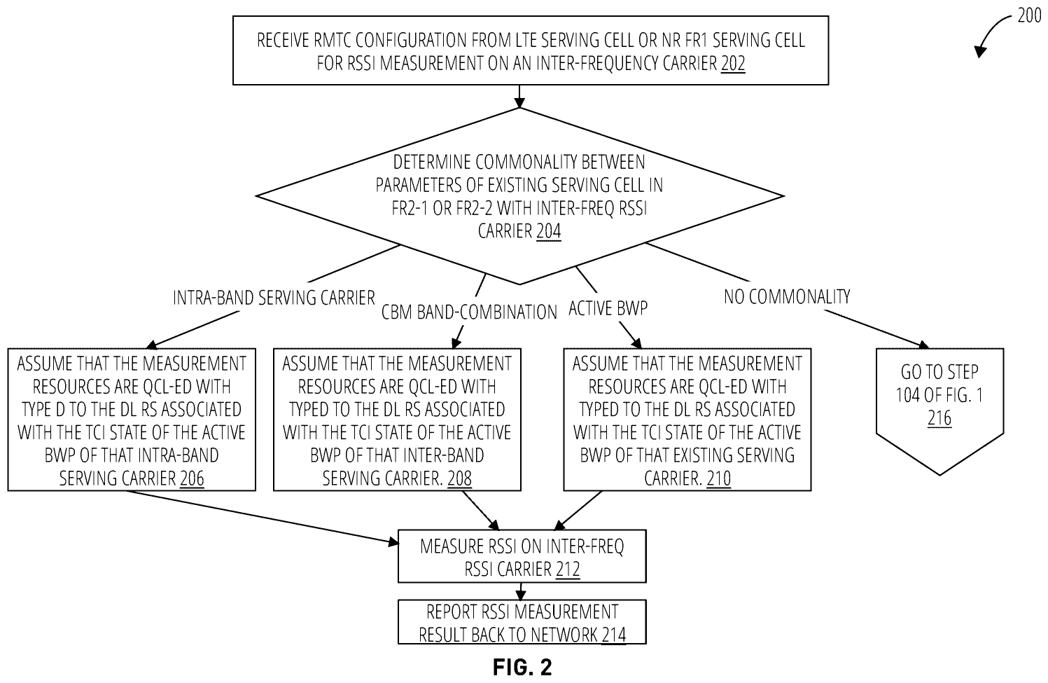

In a third option for Case 2, the UE may use beam information from an existing serving cell in FR2-1 or FR2-2. For example, FIG. 2 illustrates a flow chart of a method 200 for a UE to perform an RSSI measurement on an inter-frequency carrier using information from a serving cell in FR2-1 or FR2-2. As shown, the UE may receive 202 an RMTC configuration from an LTE serving cell or an NR FRI serving cell for RSSI measurement on an inter-frequency carrier.

The UE may make different assumptions regarding QCL type D information based on the existing inter-frequency serving cell (i.e., a serving cell in FR2-1 or FR2-2). The UE may determine 204 commonalities between parameters of the existing inter-frequency serving cell and the inter-frequency RSSI carrier.

For example, in a first situation there may be an intra-band serving carrier with the inter-frequency RSSI carrier. The intra-band serving carrier refers to a carrier that is associated with the serving cell in FR2-1 or FR2-2. The intra-band serving carrier may be in the same band as my inter-frequency RSSI carrier. The UE can use the same beam for reception in the same band. Accordingly, the UE can assume 206 that the measurement resources are QCL-ed with TypeD to the downlink reference signal associated with the TCI state of the active BWP of that intra-band serving carrier. The UE can measure 212 RSSI on the inter-frequency RSSI carrier by using the beam or QCL type D information from the intra-band serving carrier. Then the UE can report 214 RSSI measurement result back to a network node.

In a second situation there may be an inter-band serving carrier in common beam management (CBM) band-combination with the inter-frequency RSSI carrier. The network may indicate to the UE the CBM band-combination. When two bands are in CBM band-combination, the UE may use the same beam for both bands. Accordingly, the UE may use the same beam for the inter-frequency RSSI carrier as the UE used for the inter-band serving carrier. The UE can assume 208 that the measurement resources are QCL-ed with TypeD to the DL RS associated with the TCI state of the active BWP of that inter-band serving carrier. UE can measure 212 RSSI on the inter-frequency RSSI carrier by using the beam or QCL type D information from the inter-band serving carrier. Then the UE can report 214 RSSI measurement result back to a network node.

In a third situation, an active BWP of an existing serving cell can contain the inter-frequency RSSI carrier. For example, there may be employments where the UE may have a very wide active BWP (e.g., 100 MHz or 400 MHz) for an existing serving cell, and the inter-frequency RSSI carrier may be inside of the active BWP for the existing serving cell. In such a situation the UE may not need additional information because all the beams of the active BWP can be applied to inter-frequency RSSI carrier. The UE can assume 210 that the measurement resources are QCL-ed with TypeD to the downlink reference signal associated with the TCI state of the active BWP of that existing serving carrier. The UE can measure 212 RSSI on inter-frequency RSSI carrier by using the beam or QCL type D information from the active BWP of the existing serving cell. Then the UE can report 214 RSSI measurement result back to a network node.

If the UE isn't in one of the three situations described above, then the UE may use 216 method 100 of FIG. 1. The UE may apply either the first option or the second option described with reference to Case 1. Accordingly, if the commonalities do not assist the UE, the UE may use beam sweeping to measure the RSSI directly or use beam sweeping to determine the Rx beam info for RSSI measurement on target inter-frequency RSSI carrier.

### Case 3

At other times, a UE may be in a scenario where the TCI of QCLed type D is not provided to UE, and UE has no serving cell in FR2-1 or FR2-2 (i.e., Case 3). Case 3 may be approached using the option outlined below.

As the UE cannot rely on any configured TCI for the inter-frequency carrier in this scenario, the UE can perform a beam sweep. Accordingly, in this situation, the UE may employ the method 100 of FIG. 1. For example, the UE may perform the steps of method 100 similar to the second option of Case 1.

That is, the UE may receive 102, RMTC configuration from LTE serving cell or NR FR1 serving cell for RSSI measurement on an inter-frequency carrier. The UE may perform 104 the Rx beam sweeping and directly measure the RSSI to determine 106 the RSSI measurement. In other words, the UE may perform an RSSI measurement on the inter-frequency RSSI carrier by using Rx beam sweeping.

In some embodiments, the UE may use Rx beam sweeping to measure RSSI and determine the RSSI measurement results based on the strongest Rx beam. The strongest Rx beam refers to the Rx beam with the highest RSSI value. Accordingly, the UE may perform 104 a beam sweep to measure the RSSI, compare the RSSI measurements for the beams, determine 106 the RSSI measurement by selecting the RSSI measurement of the RX beam with the highest RSSI value, and report 108 the RSSI measurement of the strongest Rx beam to a network node.

In some embodiments, the UE may use Rx beam sweeping to measure RSSI and determine 106 the RSSI measurement results based on an Rx beam above a specific threshold. For example, an embodiment may have a zero decibel-milliwatts (dBm) threshold. When the UE performs 104 the Rx beam sweep, the UE determines Rx beams with an RSSI measurement above the zero dBm threshold. If there is a single Rx beam with an RSSI measurement value above the threshold the UE may report 108 the value of that Rx beam to the network node. In some embodiments, if there are multiple Rx beams with a RSSI value above the threshold, the UE may randomly select, from those Rx beams above the threshold, which Rx beam's RSSI value to report 108 to the network node.

In some embodiments, the UE may perform 104 Rx Beam sweeping and determine 106 multiple values for the RSSI measurement. For example, the UE may use Rx beam sweeping to measure RSSI and store the RSSI measurement results. In some embodiments, the UE may determine which RSSI measurement results to store by determining which Rx beams were above a specific threshold. For example, the UE may store the RSSI measurement results for Rx beams above a zero dBm threshold. In some embodiments, the UE may store all measurement results. For example if the beam sweep includes eight RSSI measurements, the UE may store all eight RSSI measurement results. The UE may report 108 the stored measurements back to the network node. To report multiple values to the network node, the RSSI measurement results may be associated with a beam index or associated with a resource signal index (e.g., QCL type D SSB index) in the report.

In some embodiments, the UE may perform 104 Rx Beam sweeping and determine 106 the RSSI measurement by taking an average of the RSSI values. For example, the UE may use Rx beam sweeping to measure RSSI and determine the RSSI measurement results based on the average of the Rx beams measured. In other words, the UE may determine an average RSSI value among Rx beams and report that average value to the network node. For example, if the UE performs a beam sweep resulting in eight RSSI values, the UE may average the eight values and report 108 the average RSSI value to the network node. In some embodiments, the average may be an average of the RSSI measurements above a specific threshold. In some embodiments, the average may be an average of all the RSSI measurements.

### Case 4

At other times, a UE may be in a scenario where the TCI of QCLed type D is not provided to UE, but UE has at least one existing serving cell in FR2-1 or FR2-2 (i.e., Case 4). Case 4 may be approached using the two options outlined below.

A first option would be to measure and report the RSSI as described with reference to the second option for case 1. Accordingly, the UE may use beam sweeping to measure the RSSI directly as described above.

In a second option for Case 2, the UE may use beam information from an existing serving cell in FR2-1 or FR2-2. For example, FIG. 2 illustrates a flow chart of a method 200 for a UE to perform an RSSI measurement on an inter-frequency carrier using information from a serving cell in FR2-1 or FR2-2. As shown, the UE may receive 202 an RMTC configuration from an LTE serving cell or an NR FR1 serving cell for RSSI measurement on an inter-frequency carrier.

The UE may make different assumptions regarding QCL type D information based on the existing inter-frequency serving cell (i.e., a serving cell in FR2-1 or FR2-2). The UE may determine 204 commonalities between parameters of the existing inter-frequency serving cell and the inter-frequency RSSI carrier.

For example, in a first situation there may be an intra-band serving carrier with the inter-frequency RSSI carrier. The intra-band serving carrier refers to a carrier that is associated with the serving cell in FR2-1 or FR2-2. The intra-band serving carrier may be in the same band as my inter-frequency RSSI carrier. The UE can use the same beam for reception in the same band. Accordingly, the UE can assume 206 that the measurement resources are QCL-ed with TypeD to the downlink reference signal associated with the TCI state of the active BWP of that intra-band serving carrier. Additionally, the TCI state of the active BWP of the intra-band serving carrier may include: downlink reference signal associated with the TCI state of the active BWP; or the QCL type-D of the latest PDSCH reception or latest CORESET monitoring. For example, if the existing serving cell already has a configured downlink reference signal, the UE can use that for the TCI state. If the downlink reference signal is not provided to the UE, the UE can use the QCL type-D of the latest PDSCH reception or latest CORESET monitoring resource.

The UE can measure 212 RSSI on the inter-frequency RSSI carrier by using the beam or QCL type D information from the intra-band serving carrier. Then the UE can report 214 RSSI measurement result back to a network node.

In a second situation there may be an inter-band serving carrier in common beam management (CBM) band-combination with the inter-frequency RSSI carrier. The network may indicate to the UE the CBM band-combination. When two bands are in CBM band-combination, the UE may use the same beam for both bands. Accordingly, the UE may use the same beam for the inter-frequency RSSI carrier as the UE used for the inter-band serving carrier. The UE can assume 208 that the measurement resources are QCL-ed with TypeD to the DL RS associated with the TCI state of the active BWP of that inter-band serving carrier. Additionally, the TCI state of the active BWP of the inter-band serving carrier may include: downlink reference signal associated with the TCI state of the active BWP; or the QCL type-D of the latest PDSCH reception or latest CORESET monitoring.

UE can measure 212 RSSI on the inter-frequency RSSI carrier by using the beam or QCL type D information from the inter-band serving carrier. Then the UE can report 214 RSSI measurement result back to a network node.

In a third situation, an active BWP of an existing serving cell can contain the inter-frequency RSSI carrier. For example, there may be employments where the UE may have a very wide active BWP (e.g., 100 MHz or 400 MHz) for an existing serving cell, and the inter-frequency RSSI carrier may be inside of the active BWP for the existing serving cell. In such a situation the UE may not need additional information because all the beams of the active BWP can be applied to inter-frequency RSSI carrier. The UE can assume 210 that the measurement resources are QCL-ed with TypeD to the downlink reference signal associated with the TCI state of the active BWP of that existing serving carrier. Additionally, the TCI state of the active BWP of the inter-band serving carrier may include: downlink reference signal associated with the TCI state of the active BWP; or the QCL type-D of the latest PDSCH reception or latest CORESET monitoring.

The UE can measure 212 RSSI on inter-frequency RSSI carrier by using the beam or QCL type D information from the active BWP of the existing serving cell. Then the UE can report 214 RSSI measurement result back to a network node.

If the UE isn't in one of the three situations described above, then the UE may use 216 method 100 of FIG. 1. The UE may apply the second option described with reference to Case 1. Accordingly, if the commonalities do not assist the UE, the UE may use beam sweeping to measure the RSSI.

Embodiments contemplated herein include an apparatus comprising means to perform one or more elements of the method 100 and the method 200. This apparatus may be, for example, an apparatus of a UE (such as a wireless device 402 that is a UE, as described herein).

Embodiments contemplated herein include one or more non-transitory computer-readable media comprising instructions to cause an electronic device, upon execution of the instructions by one or more processors of the electronic device, to perform one or more elements of the method the method 100 and the method 200. This non-transitory computer-readable media may be, for example, a memory of a UE (such as a memory 406 of a wireless device 402 that is a UE, as described herein).

Embodiments contemplated herein include an apparatus comprising logic, modules, or circuitry to perform one or more elements of the method the method 100 and the method 200. This apparatus may be, for example, an apparatus of a UE (such as a wireless device 402 that is a UE, as described herein).

Embodiments contemplated herein include an apparatus comprising: one or more processors and one or more computer-readable media comprising instructions that, when executed by the one or more processors, cause the one or more processors to perform one or more elements of the method the method 100 and the method 200. This apparatus may be, for example, an apparatus of a UE (such as a wireless device 402 that is a UE, as described herein).

Embodiments contemplated herein include a signal as described in or related to one or more elements of the method the method 100 and the method 200.

Embodiments contemplated herein include a computer program or computer program product comprising instructions, wherein execution of the program by a processor is to cause the processor to carry out one or more elements of the method the method 100 and the method 200. The processor may be a processor of a UE (such as a processor(s) 404 of a wireless device 402 that is a UE, as described herein). These instructions may be, for example, located in the processor and/or on a memory of the UE (such as a memory 406 of a wireless device 402 that is a UE, as described herein).

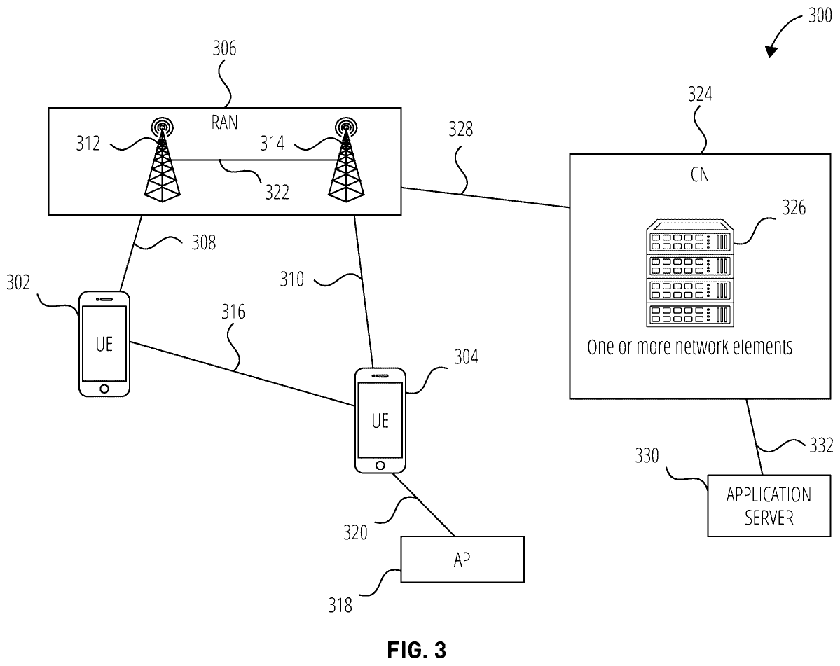

FIG. 3 illustrates an example architecture of a wireless communication system 300, according to embodiments disclosed herein. The following description is provided for an example wireless communication system 300 that operates in conjunction with the LTE system standards and/or 5G or NR system standards as provided by 3GPP technical specifications.

As shown by FIG. 3, the wireless communication system 300 includes UE 302 and UE 304 (although any number of UEs may be used). In this example, the UE 302 and the UE 304 are illustrated as smartphones (e.g., handheld touchscreen mobile computing devices connectable to one or more cellular networks), but may also comprise any mobile or non-mobile computing device configured for wireless communication.

The UE 302 and UE 304 may be configured to communicatively couple with a RAN 306. In embodiments, the RAN 306 may be NG-RAN, E-UTRAN, etc. The UE 302 and UE 304 utilize connections (or channels) (shown as connection 308 and connection 310, respectively) with the RAN 306, each of which comprises a physical communications interface. The RAN 306 can include one or more base stations (such as base station 312 and base station 314) that enable the connection 308 and connection 310.

In this example, the connection 308 and connection 310 are air interfaces to enable such communicative coupling, and may be consistent with RAT(s) used by the RAN 306, such as, for example, an LTE and/or NR.

In some embodiments, the UE 302 and UE 304 may also directly exchange communication data via a sidelink interface 316. The UE 304 is shown to be configured 14 to access an access point (shown as AP 318) via connection 320. By way of example, the connection 320 can comprise a local wireless connection, such as a connection consistent with any IEEE 802.11 protocol, wherein the AP 318 may comprise a Wi-Fi® router. In this example, the AP 318 may be connected to another network (for example, the Internet) without going through a CN 324.

In embodiments, the UE 302 and UE 304 can be configured to communicate using orthogonal frequency division multiplexing (OFDM) communication signals with each other or with the base station 312 and/or the base station 314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 312 or base station 314 may be implemented as one or more software entities running on server computers as part of a virtual network. In addition, or in other embodiments, the base station 312 or base station 314 may be configured to communicate with one another via interface 322. In embodiments where the wireless communication system 300 is an LTE system (e.g., when the CN 324 is an EPC), the interface 322 may be an X2 interface. The X2 interface may be defined between two or more base stations (e.g., two or more eNBs and the like) that connect to an EPC, and/or between two eNBs connecting to the EPC. In embodiments where the wireless communication system 300 is an NR system (e.g., when CN 324 is a 5GC), the interface 322 may be an Xn interface. The Xn interface is defined between two or more base stations (e.g., two or more gNBs and the like) that connect to 5GC, between a base station 312 (e.g., a gNB) connecting to 5GC and an eNB, and/or between two eNBs connecting to 5GC (e.g., CN 324).

The RAN 306 is shown to be communicatively coupled to the CN 324. The CN 324 may comprise one or more network elements 326, which are configured to offer various data and telecommunications services to customers/subscribers (e.g., users of UE 302 and UE 304) who are connected to the CN 324 via the RAN 306. The components of the CN 324 may be implemented in one physical device or separate physical devices including components to read and execute instructions from a machine-readable or computer-readable medium (e.g., a non-transitory machine-readable storage medium).

In embodiments, the CN 324 may be an EPC, and the RAN 306 may be connected with the CN 324 via an S1 interface 328. In embodiments, the S1 interface 328 may be split into two parts, an S1 user plane (S1-U) interface, which carries traffic data between the base station 312 or base station 314 and a serving gateway (S-GW), and the S1-MME interface, which is a signaling interface between the base station 312 or base station 314 and mobility management entities (MMEs).

In embodiments, the CN 324 may be a 5GC, and the RAN 306 may be connected with the CN 324 via an NG interface 328. In embodiments, the NG interface 328 may be split into two parts, an NG user plane (NG-U) interface, which carries traffic data between the base station 312 or base station 314 and a user plane function (UPF), and the SI control plane (NG-C) interface, which is a signaling interface between the base station 312 or base station 314 and access and mobility management functions (AMFs).

Generally, an application server 330 may be an element offering applications that use internet protocol (IP) bearer resources with the CN 324 (e.g., packet switched data services). The application server 330 can also be configured to support one or more communication services (e.g., VoIP sessions, group communication sessions, etc.) for the UE 302 and UE 304 via the CN 324. The application server 330 may communicate with the CN 324 through an IP communications interface 332.

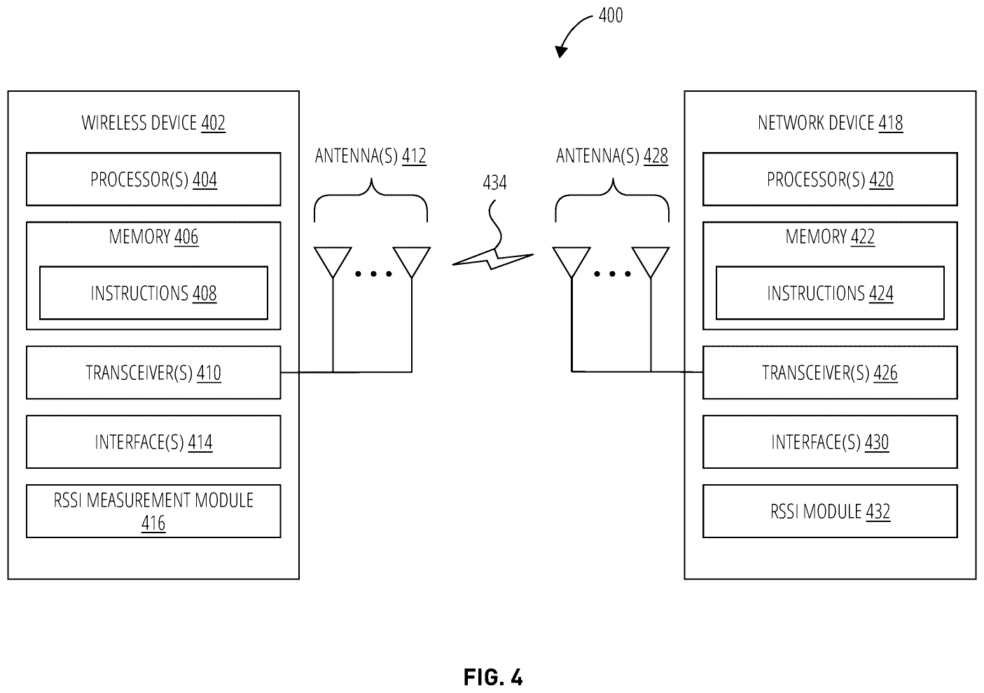

FIG. 4 illustrates a system 400 for performing signaling 434 between a wireless device 402 and a network device 418, according to embodiments disclosed herein. The system 400 may be a portion of a wireless communications system as herein described. The wireless device 402 may be, for example, a UE of a wireless communication system. The network device 418 may be, for example, a base station (e.g., an eNB or a gNB) of a wireless communication system.

The wireless device 402 may include one or more processor(s) 404. The processor(s) 404 may execute instructions such that various operations of the wireless device 402 are performed, as described herein. The processor(s) 404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 402 may include a memory 406. The memory 406 may be a non-transitory computer-readable storage medium that stores instructions 408 (which may include, for example, the instructions being executed by the processor(s) 404). The instructions 408 may also be referred to as program code or a computer program. The memory 406 may also store data used by, and results computed by, the processor(s) 404.

The wireless device 402 may include one or more transceiver(s) 410 that may include radio frequency (RF) transmitter and/or receiver circuitry that use the antenna(s) 412 of the wireless device 402 to facilitate signaling (e.g., the signaling 434) to and/or from the wireless device 402 with other devices (e.g., the network device 418) according to corresponding RATs.

The wireless device 402 may include one or more antenna(s) 412 (e.g., one, two, four, or more). For embodiments with multiple antenna(s) 412, the wireless device 402 may leverage the spatial diversity of such multiple antenna(s) 412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 402 may be accomplished according to precoding (or digital beamforming) that is applied at the wireless device 402 that multiplexes the data streams across the antenna(s) 412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 402 may implement analog beamforming techniques, whereby phases of the signals sent by the antenna(s) 412 are relatively adjusted such that the (joint) transmission of the antenna(s) 412 can be directed (this is sometimes referred to as beam steering).

The wireless device 402 may include one or more interface(s) 414. The interface(s) 414 may be used to provide input to or output from the wireless device 402. For example, a wireless device 402 that is a UE may include interface(s) 414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 410/antenna(s) 412 already described) that allow for communication between the UE and other devices and may operate according to known protocols (e.g., Wi-Fi®, Bluetooth®, and the like).

The wireless device 402 may include an RSSI measurement module 416. The RSSI measurement module 416 may be implemented via hardware, software, or combinations thereof. For example, the RSSI measurement module 416 may be implemented as a processor, circuit, and/or instructions 408 stored in the memory 406 and executed by the processor(s) 404. In some examples, the RSSI measurement module 416 may be integrated within the processor(s) 404 and/or the transceiver(s) 410. For example, the RSSI measurement module 416 may be implemented by a combination of software components (e.g., executed by a DSP or a general processor) and hardware components (e.g., logic gates and circuitry) within the processor(s) 404 or the transceiver(s) 410.

The RSSI measurement module 416 may be used for various aspects of the present disclosure, for example, aspects of FIGS. 1-3. The RSSI measurement module 416 is configured to measure RSSI on an inter-frequency carrier and report the RSSI to the network device 418.

The network device 418 may include one or more processor(s) 420. The processor(s) 420 may execute instructions such that various operations of the network device 418 are performed, as described herein. The processor(s) 420 may include one or more baseband processors implemented using, for example, a CPU, a DSP, an ASIC, a controller, an FPGA device, another hardware device, a firmware device, or any combination thereof configured to perform the operations described herein.

The network device 418 may include a memory 422. The memory 422 may be a non-transitory computer-readable storage medium that stores instructions 424 (which may include, for example, the instructions being executed by the processor(s) 420). The instructions 424 may also be referred to as program code or a computer program. The memory 422 may also store data used by, and results computed by, the processor(s) 420.

The network device 418 may include one or more transceiver(s) 426 that may include RF transmitter and/or receiver circuitry that use the antenna(s) 428 of the network device 418 to facilitate signaling (e.g., the signaling 434) to and/or from the network device 418 with other devices (e.g., the wireless device 402) according to corresponding RATs.

The network device 418 may include one or more antenna(s) 428 (e.g., one, two, four, or more). In embodiments having multiple antenna(s) 428, the network device 418 may perform MIMO, digital beamforming, analog beamforming, beam steering, etc., as has been described.

The network device 418 may include one or more interface(s) 430. The interface(s) 430 may be used to provide input to or output from the network device 418. For example, a network device 418 that is a base station may include interface(s) 430 made up of transmitters, receivers, and other circuitry (e.g., other than the transceiver(s) 426/antenna(s) 428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 418 may include an RSSI module 432. The RSSI module 432 may be implemented via hardware, software, or combinations thereof. For example, the RSSI module 432 may be implemented as a processor, circuit, and/or instructions 424 stored in the memory 422 and executed by the processor(s) 420. In some examples, the RSSI module 432 may be integrated within the processor(s) 420 and/or the transceiver(s) 426. For example, the RSSI module 432 may be implemented by a combination of software components (e.g., executed by a DSP or a general processor) and hardware components (e.g., logic gates and circuitry) within the processor(s) 420 or the transceiver(s) 426.

The RSSI module 432 may be used for various aspects of the present disclosure, for example, aspects of FIGS. 1-3. The RSSI module 432 is configured to configure RMTC for RSSI measurement on an inter-frequency carrier, and receive an RSSI report from the wireless device 402.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
receiving a configuration from a long term evolution (LTE) serving cell or a new radio (NR) Frequency Range 1 (FR1) serving cell for a layer 3 (L3) measurement on an inter-frequency carrier;
performing reception (Rx) beam sweeping;
determining one or more inter-frequency carrier L3 measurements based on the Rx beam sweeping; and
reporting the one or more inter-frequency carrier L3 measurements to a network node.

2. The method of claim 1, wherein performing Rx beam sweeping comprises using local Rx beams to measure a reference signal (RS) Reference Signal Received Power (RSRP), Reference Signal Received Quality (RSRQ), or Signal to Interference and Noise Ratio (SINR); and
wherein determining the one or more inter-frequency carrier L3 measurements comprises:
determining Rx beam information for the L3 measurement on the inter-frequency carrier based on the RSRP, the RSRQ, or the SINR; and
measuring received signal strength indicator (RSSI) on the inter-frequency carrier by using the Rx beam information.

3. The method of claim 1, wherein received signal strength indicator (RSSI) is measured on the inter-frequency carrier using the beam sweeping.

4. The method of claim 3, wherein the one or more inter-frequency carrier L3 measurements comprises a highest RSSI value.

5. The method of claim 3, wherein the one or more inter-frequency carrier L3 measurements comprises an RSSI value of an Rx beam that is above a threshold.

6. The method of claim 3, wherein the one or more inter-frequency carrier L3 measurements comprises RSSI values from multiple Rx beams.

7. The method of claim 6, wherein the UE associates the RSSI values from multiple Rx beams with a beam index or reference signal index to report the RSSI values.

8. The method of claim 3, wherein the one or more inter-frequency carrier L3 measurements comprises an average RSSI value of Rx beams measured using the beam sweeping.

9. The method of claim 1, further comprising:
determining when there is an intra-band serving carrier with an RSSI measurement object on the inter-frequency carrier, and
measuring RSSI on the inter-frequency carrier by using beam or quasi co-location (QCL) type D information for a downlink reference signal associated with a Transmission Configuration Indication (TCI) state of an active bandwidth part (BWP) of the intra-band serving carrier.

10. The method of claim 9, wherein the TCI state of the active BWP of the intra-band serving carrier includes the downlink reference signal associated with the TCI state of the active BWP, or the QCL type D of a latest Physical Downlink Shared Channel (PDSCH) reception or latest Control Resource Set (CORESET) monitoring.

11. The method of claim 1, further comprising:
determining when there is an inter-band serving carrier in CBM band-combination with an RSSI measurement object on the inter-frequency carrier; and
measuring received signal strength indicator (RSSI) on the inter-frequency carrier by using beam or quasi co-location (QCL) type D information for a downlink reference signal associated with Transmission Configuration Indication (TCI) state of an active bandwidth part (BWP) of the inter-band serving carrier.

12. The method of claim 11, wherein the TCI state of the active BWP of the inter-band serving carrier includes the downlink reference signal associated with the TCI state of the active BWP, or the QCL type D of a latest Physical Downlink Shared Channel (PDSCH) reception or latest Control Resource Set (CORESET) monitoring.

13. The method of claim 1, further comprising:
determining when there is an active bandwidth part (BWP) of an existing serving cell that contains an inter-frequency carrier RSSI measurement object; and
measuring received signal strength indicator (RSSI) on the inter-frequency carrier by using beam or quasi co-location (QCL) type D information for a downlink reference signal associated with Transmission Configuration Indication (TCI) state of the active BWP of the existing serving carrier.

14. The method of claim 13, wherein the TCI state of the active BWP of the inter-band serving carrier includes the downlink reference signal associated with the TCI state of the active BWP, or the QCL type D of a latest Physical Downlink Shared Channel (PDSCH) reception or latest Control Resource Set (CORESET) monitoring.

15. A non-transitory computer-readable storage medium, the computer-readable storage medium including instructions that when executed by a computer, cause the computer to:
receive a configuration from a long term evolution (LTE) serving cell or a new radio (NR) Frequency Range 1 (FR1) serving cell for a layer 3 (L3) measurement on an inter-frequency carrier;
perform reception (Rx) beam sweeping using local Rx beams to measure this a reference signal (RS) Reference Signal Received Power (RSRP), Reference Signal Received Quality (RSRQ), or Signal to Interference and Noise Ratio (SINR); and
determine Rx beam information for the L3 measurement on the inter-frequency carrier based on the RSRP, the RSRQ, or the SINR;
measure the L3 measurement on the inter-frequency carrier by using the Rx beam information; and
report the L3 measurements to a network node.

16. The non-transitory computer-readable storage medium of claim 15, wherein the L3 measurement is received signal strength indicator (RSSI).

17. The non-transitory computer-readable storage medium of claim 15, wherein the Rx beam information is based on a strongest measurement result of the RSRP, the RSRQ, or the SINR.

18. The non-transitory computer-readable storage medium of claim 15, wherein the Rx beam information is based on results of the RSRP, the RSRQ, or the SINR above a threshold.

19. A computing apparatus comprising:
a processor; and
a memory storing instructions that, when executed by the processor, configure the apparatus to:
receive a configuration from a long term evolution (LTE) serving cell or a new radio (NR) Frequency Range 1 (FR1) serving cell for a layer 3 (L3) measurement on an inter-frequency carrier;
performing the L3 measurement using reception (Rx) beam sweeping;
determine one or more inter-frequency carrier L3 measurements based on the Rx beam sweeping; and
report the one or more inter-frequency carrier L3 measurements to network node.

20. The computing apparatus of claim 19, wherein the L3 measurement is received signal strength indicator (RSSI).
